(19) United States
(12) Patent Application Publication
(10) Pub. No.: US 2013/0228937 A1
(43) Pub. Date: Sep. 5, 2013

(54) Micromechanical Sound Transducer Arrangement and a Corresponding Production Method

(71) Applicant: ROBERT BOSCH GMBH, Stuttgart, DE (US)

(72) Inventors: Ricardo Ehrenpfordt, Korntal-Muenchingen (DE); Mathias Bruendel, Stuttgart (DE); Andre Gerlach, Leonberg-Hoefingen (DE); Christina Leinenbach, Karlsruhe (DE); Sonja Knies, Rutesheim (DE); Ando Feyh, Palo Alto, CA (US); Ulrike Scholz, Korntal (DE)

(73) Assignee: Robert Bosch GmbH, Stuttgart (DE)

(21) Appl. No.: 13/782,566

(22) Filed: Mar. 1, 2013

(30) Foreign Application Priority Data
Mar. 5, 2012 (DE) 10 2012 203 373.4

(51) Int. Cl. H04R 23/00; H04R 31/00

(52) U.S. Cl. CPC H04R 23/006; H04R 31/00
USPC 257/778; 438/26

(57) ABSTRACT

A micromechanical sound transducer arrangement includes an electrical printed circuit board having a front side and a rear side. A micromechanical sound transducer structure is applied to the front side using the flip-chip method. The printed circuit board defines an opening for emitting soundwaves in the region of the micromechanical sound transducer structure.

This application claims priority under 35 U.S.C. §119 to patent application no. DE 10 2012 203 373.4, filed on Mar. 5, 2012 in Germany, the disclosure of which is incorporated herein by reference in its entirety.

### BACKGROUND

The present disclosure relates to a micromechanical sound transducer arrangement and a corresponding production method.

Although applicable, in principle, to arbitrary micromechanical sound transducer arrangements, for example loudspeakers and microphones, the present disclosure and the problem addressed thereby will be explained with reference to silicon-based micromechanical loudspeaker arrangements.

Micromechanical loudspeaker arrangements, also designated as MEMS loudspeaker arrangements, nowadays require a complex and very cost-intensive packing technology. The complex singulation of the fragile, uncapped MEMS structures and the packaging thereof with an acoustically transparent window, usually a thin film, necessitates packaging costs of the order of magnitude of 1 euro per chip, and these packaging costs are therefore a factor of 20 to 30 higher than the packaging costs for other micromechanical sensors, such as e.g. inertial sensors.

Packing by means of a mold package, such as, for example, in the case of micromechanical-based inertial sensors comprising an MEMS loudspeaker element and an ASIC cannot be realized for micromechanical loudspeaker arrangements.

DE 10 2005 056 759 A1 discloses a micromechanical structure for receiving and/or for generating acoustic signals, which comprises a first mating element having first openings and substantially forming a first side of the structure, wherein the structure furthermore comprises a second mating element having second openings and substantially forming a second side of the structure. The structure is substantially closed and comprises a membrane arranged between the first mating element and the second mating element.

to DE 10 2005 055 478 A1 likewise discloses a micromechanical structure for receiving and/or for generating acoustic signals.

### SUMMARY

The present disclosure makes possible an efficient packaging technology for MEMS sound transducer arrangements.

The concept underlying the present disclosure is based on a construction by means of flip-chip technology on a printed circuit board, wherein the printed circuit board has an acoustic port or an acoustic window. Consequently, there is no need for any through-contacts in the printed circuit board, in the micromechanical sound transducer arrangement or in the ASIC.

The disclosure thus makes possible a higher integration density, smaller structural heights and considerable cost savings. The structural height is a central advantage of MEMS sound transducer arrangements by comparison with conventional sound transducers. A separate package is not necessary, and, according to the disclosure, the printed circuit board simultaneously serves as a packaging element.

The micromechanical sound transducer arrangement can be realized together with an ASIC on the printed circuit board or else discretely in a modular approach.

In accordance with one preferred development, the opening, on the rear side, is mechanically closed by a protective film. Besides the function as an acoustic window, the protective film serves to protect the micromechanical loudspeaker arrangement against external influences, such as e.g. dust and moisture. The protective film, which preferably forms the acoustic window, need not be applied at the wafer level, but rather can be implemented with the production of the printed circuit board, which is an extremely cost-effective manufacturing step.

to In accordance with a further preferred development, on the front side, a circumferential protective ring is provided between the printed circuit board and the micromechanical sound transducer structure. Said protective ring has the advantage that it forms a mechanical protection.

In accordance with a further preferred development, an ASIC chip is furthermore applied to the front side of the printed circuit board using the flip-chip method. This has the advantage that an evaluation circuit can be mounted in the same mounting process as the sound transducer structure.

In accordance with a further preferred development, the micromechanical sound transducer structure has a first structural height, and wherein solder balls are provided in the periphery of the micromechanical sound transducer structure, said solder balls having a second structural height, which is higher than the first structural height. A packaging can thus easily be fitted over the sound transducer structure.

In accordance with a further preferred development, the printed circuit board is connected to a device board via the solder balls. Device coupling can thus be realized in an expedient manner.

In accordance with a further preferred development, the protective film consists of Mylar and has a thickness of one to a few micrometers. Such a protective film affords good sound transparency and, moreover, is stable.

### BRIEF DESCRIPTION OF THE DRAWINGS

The present disclosure will be explained in greater detail below on the basis of the exemplary embodiments indicated in the schematic figures of the drawings, in which:

to FIG. 1 shows a micromechanical loudspeaker arrangement in accordance with one embodiment of the present disclosure; and

FIG. 2 shows a micromechanical loudspeaker structure which can be employed in the case of the embodiment in accordance with FIG. 1.

### DETAILED DESCRIPTION

In FIG. 1, reference sign 1 designates an electrical printed circuit board having a front side VS and a rear side RS. On the front side VS, the printed circuit board 1 is populated with an ASIC 2 and a micromechanical loudspeaker structure 3 using the flip-chip method. Electrical solder balls as flip-chip bonds are designated by reference sign 4a. For reasons of simplification, a redistribution wiring realized in the printed circuit board is not illustrated in FIG. 1. The micromechanical loudspeaker structure 3 can be protected from the environment by a circumferential solder frame 4b, for example. As an alternative thereto, an adhesive film could be provided instead of the circumferential solder frame 4b, in which case said adhesive film does not effect electrical contact-making, but rather only mechanical protection.

The printed circuit board 1 furthermore has an opening structure that defines a hole-shaped opening 5, wherein, on the rear side RS of the printed circuit board 1, said opening is mechanically closed with a protective film 6, e.g. Mylar having a thickness of a few micrometers, but allows an acoustic passage of soundwaves S.

Moreover, the protective film 6 serves to protect the micromechanical loudspeaker arrangement against external influences, such as e.g. dust and moisture. The soundwaves S are emitted in the direction of the arrow through the opening 5.

to Further solder balls 7 are applied on the front side of the printed circuit board 1, said further solder balls having a height h2 greater than the height h1 of the ASIC 2 or of the micromechanical loudspeaker structure 3.

By means of said further solder balls 7, the printed circuit board 1 populated with the ASIC 2 and the micromechanical loudspeaker arrangement 3 can be mounted onto a device printed circuit board 10, for example of a mobile telephone. This can likewise be done using the flip-chip method. Said device printed circuit board 10 is only indicated schematically in FIG. 1.

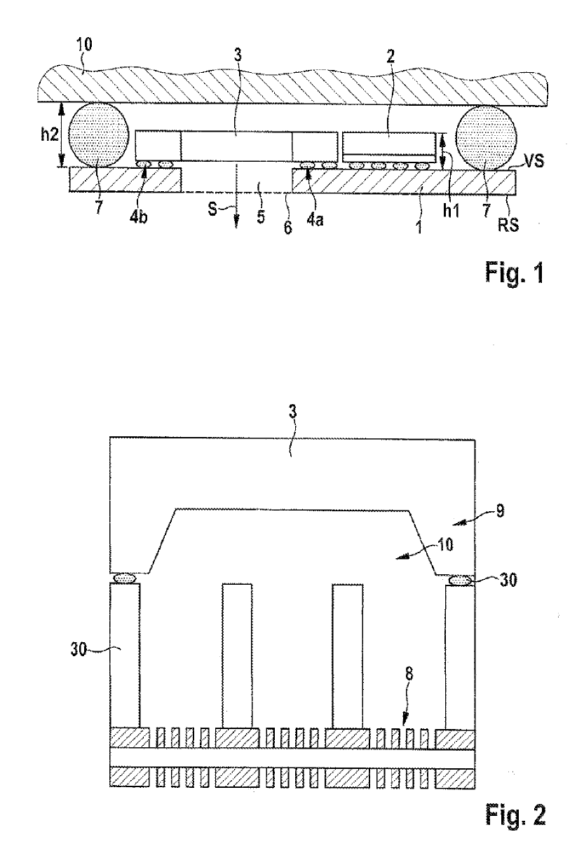

FIG. 2 shows one possible embodiment of the micromechanical loudspeaker structure 3 in detail. Acoustically active elements 8 in a substrate wafer 30 in the lower region of the micromechanical loudspeaker structure 3 serve for sound emission. The opposite side is closed by a cap wafer 9 having a cavity 10. The cavity 10 serves as a common back volume in order to minimize air damping. The cap wafer 9 is connected to the substrate wafer 30 by means of adhesive 30. On the other hand, it is also possible for the closure to be effected by adhesive bonding by means of a polymer element (not shown) instead of the cap wafer 9.

Although the present disclosure has been described completely on the basis of preferred exemplary embodiments above, it is not restricted thereto, but rather can be modified in diverse ways.

What is claimed is:

1. A micromechanical sound transducer arrangement comprising:
an electrical printed circuit board defining a front side, a rear side, and an opening; and
a micromechanical sound transducer structure configured to be applied to the front side using a flip-chip method,
wherein the opening is configured to emit soundwaves in a region of the to micromechanical sound transducer structure.

2. The micromechanical sound transducer arrangement according to claim 1, further comprising:
a protective film configured to mechanically close the opening on the rear side.

3. The micromechanical sound transducer arrangement according to claim 1, further comprising:
a circumferential protective ring located on the front side between the printed circuit board and the micromechanical sound transducer structure.

4. The micromechanical sound transducer arrangement according to claim 1, further comprising:
an ASIC chip applied to the front side of the printed circuit board,
wherein the ASIC chip is configured to be applied using the flip-chip method.

5. The micromechanical sound transducer arrangement according to claim 1, wherein:
the micromechanical sound transducer structure defines a first structural height,
a plurality of solder balls are located in a periphery of the micromechanical sound transducer structure,
the plurality of solder balls define a second structural height, and
the second structural height is higher than the first structural height.

6. The micromechanical sound transducer arrangement according to claim 5, wherein to the printed circuit board is connected to a device board via the plurality of solder balls.

7. The micromechanical sound transducer arrangement according to claim 2, wherein:
the protective film includes Mylar, and
the protective film defines a thickness of one to five micrometers.

8. A method for producing a micromechanical sound transducer arrangement comprising:
providing an electrical printed circuit board defining a front side, a rear side, and an opening; and
applying a micromechanical sound transducer structure to the front side of the printed circuit board using a flip-chip method, such that the opening is located in a region of the micromechanical sound transducer structure.

9. The method for producing a micromechanical sound transducer arrangement according to claim 8, further comprising:
closing the opening on the rear side of the printed circuit board with a protective film.

10. The method for producing a micromechanical sound transducer arrangement according to claim 9, wherein:
the micromechanical sound transducer structure defines a first structural height,
a plurality of solder balls are located in a periphery of the micromechanical sound transducer structure,
the plurality of solder balls define a second structural height, and
the second structure height is higher than the first structural height.

11. The method for producing a micromechanical sound transducer arrangement according to claim 10, further comprising:
connecting the printed circuit board to a device with via the plurality of solder balls.

12. The method for producing a micromechanical sound transducer arrangement according to claim 8, further comprising:
applying an ASIC chip on the front side of the electrical printed circuit board using the flip-chip method.
